(19) United States
(12) Patent Application Publication
(10) Pub. No.: US 2013/0253110 A1
(43) Pub. Date: Sep. 26, 2013

(54) UREA COMPOUNDS FOR IMPROVING THE SOLID STATE PROPERTIES OF POLYAMIDE RESINS

(71) Applicant: BASF SE, Ludwigshafen (DE)

(72) Inventors: Claus Gabriel, Griesheim (DE); Hans-Werner Schmidt, Bayreuth (DE); Florian Richter, Burgkunstadt (DE)

(73) Assignee: BASF SE, Ludwigshafen (DE)

(21) Appl. No.: 13/847,801

(22) Filed: Mar. 20, 2013

Related U.S. Application Data
(60) Provisional application No. 61/612,998, filed on Mar. 20, 2012.

(51) Int. Cl. C08K 5/21

(52) U.S. Cl. CPC C08K 5/21
USPC 524/212

(57) ABSTRACT

The present invention relates to the use of at least one urea compound of the formula I

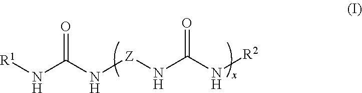

where x is 1, 2 or 3; R¹ and R² are selected from hydrogen, linear C₁-C₇-alkyl, branched C₃-C₁₀-alkyl, unsubstituted or substituted C₃-C₁₂-cycloalkyl, unsubstituted or substituted C₃-C₁₂-cycloalkyl-C₁-C₄-alkyl, unsubstituted or substituted aryl and unsubstituted or substituted aryl-C₁-C₄-alkyl; and Z is selected from C₃-C₁₀-alkanediyl, unsubstituted or substituted arylene, unsubstituted or substituted arylene-C₁-C₄-alkylene-arylene, unsubstituted or substituted heteroarylene, unsubstituted or substituted heteroarylene-C₁-C₄-alkylene-heteroarylene, unsubstituted or substituted C₅-C₈-cycloalkylene, unsubstituted or substituted C₅-C₈-cycloalkylene-C₁-C₄-alkylene-C₅-C₈-cycloalkylene, unsubstituted or substituted heterocycloalkylene and unsubstituted or substituted heterocycloalkylene-C₁-C₄-alkylene-heterocycloalkylene for improving at least one solid state property of a polyamide resin. The solid state property is preferably selected from mechanical properties and gloss.

The present invention relates to the use of an urea compound for improving the solid state properties of polyamide resins. More particularly, the present invention relates to the use of an urea compound for improving the mechanical properties and gloss of polyamide resins.

Polyamide (PA) is a well known commercial polymer, used in many different applications due to its very good performance properties and low cost, e.g. in automotive, aircraft, mechanical engineering, electrical, electronics, sport and leisure industries. It is often sought to modify polyamide resins in order to impart advantageous properties to articles shaped therefrom or from compositions comprising them, the properties including mechanical properties, such as enhanced modulus of elasticity, tensile stress at break, tensile strain at break or notched impact toughness and appearance such as improved surface gloss. In particular, it is desirable that polyamide resins have good mechanical properties at high temperatures, e.g. above the glass transition temperature T_{G}. These polyamides could be used for the manufacture of mechanically stressed parts which are exposed in use to high temperatures. Good stiffness/toughness properties of the polyamide resin are also required with respect to the manufacture of thin-walled parts.

It is known that the incorporation of talc into polyamide resins improves stiffness and flexural strength of polyamide resins. However, this results in a reduction of tensile properties and impact toughness.

JP 5320501 describes polyamide resin compositions comprising a polyamide resin, barium stearate as release agent and a bisurea compound of the formula (R¹—NHC(O)NH)₂×, where X is a bivalent hydrocarbon group and R¹ is an aliphatic hydrocarbon group having 9 to 40 C atoms, with enhanced flow, crystallization and release properties. The combination of barium stearate and the bisurea compound imparts injection-mouldable polyamide resins a high resistance to ejection distortion.

Accordingly, there is a constant need for polyamide resins having improved solid state properties in order to widen the performance spectrum. The solid state properties include mechanical properties and gloss properties such as surface gloss properties. Especially, there is a great need for polyamide resins that show good mechanical properties.

It has now been surprisingly found that urea compounds of the formula I as defined below are suitable for improving the solid state properties of polyamide resins.

The invention relates, accordingly, to the use of at least one urea compound of the formula I

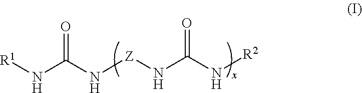

where
x is 1, 2 or 3;
R¹ and R² are, independently of each other, selected from hydrogen, linear C₁-C₇-alkyl, branched C₃-C₁₀-alkyl, unsubstituted or substituted C₃-C₁₂-cycloalkyl, unsubstituted or substituted C₃-C₁₂-cycloalkyl-C₁-C₄-alkyl, unsubstituted or substituted aryl and unsubstituted or substituted aryl-C₁-C₄-alkyl; and
Z is selected from C₃-C₁₀-alkanediyl, unsubstituted or substituted arylene, unsubstituted or substituted arylene-C₁-C₄-alkylene-arylene, unsubstituted or substituted heteroarylene, unsubstituted or substituted heteroarylene-C₁-C₄-alkylene-heteroarylene, unsubstituted or substituted C₅-C₈-cycloalkylene, unsubstituted or substituted C₅-C₈-cycloalkylene-C₁-C₄-alkylene-C₅-C₈-cycloalkylene, unsubstituted or substituted heterocycloalkylene and unsubstituted or substituted heterocycloalkylene-C₁-C₄-alkylene-heterocycloalkylene,
   for improving the solid state properties of a polyamide resin. Especially, the solid state properties are selected from mechanical properties and gloss.

The invention also provides a method for improving the solid material properties of a polyamide resin, which comprises adding to the polyamide resin at least one urea compound of the formula I as defined above.

In the terms of the present invention “solid state properties of a polyamide resin” are understood to be properties of the polyamide in the solid state. Solid state properties are preferably selected from gloss and mechanical properties. Mechanical properties include for example the modulus of shear and tensile properties such as yield stress, yield strain, tensile strain at break, tensile stress at break, modulus of elasticity in tension and notched impact toughness.

The inventive use of the urea compound of the formula I is accompanied by at least one of the following advantages when comparison is made with a composition without said addition:
improvement of at least one mechanical property, in particular, notched impact toughness, tensile stress at break, tensile strain at break, Young's modulus (modulus of elasticity) and modulus of shear;
enhancement of gloss.

As used herein, the term “semicrystalline” describes a polyamide polymer that exhibits X-ray patterns that have sharp features characteristic of crystalline regions and diffuse features characteristic of amorphous regions.

For the purposes of the present invention collective terms are used for the definitions of the variables that are indicated in the formulae, with these collective terms standing generally and representatively for the substituents in question. The definition Cₙ-Cₘ indicates the possible number of respective carbon atoms in the respective substituent or substituent moiety.

The term “C₁-C₄-alkyl” as used herein denotes a straight-chain or branched alkyl group having from 1 to 4 carbon atoms. Examples are methyl, ethyl, n-propyl, iso-propyl, n-butyl, 2-butyl, iso-butyl and tert-butyl.

The term “linear C₁-C₇-alkyl” as used herein denotes a straight-chain alkyl group having from 1 to 7 carbon atoms. Examples are methyl, ethyl, n-propyl, n-butyl, n-pentyl, n-hexyl and n-heptyl.

The term “branched C₃-C₁₀-alkyl” as used herein denotes a branched alkyl group having form 3 to 10 carbon atom. Examples are iso-propyl, 2-butyl, iso-butyl, tert-butyl, 1-methylbutyl, 2-methylbutyl, 3-methylbutyl, 2,2-dimethylpropyl, 1-ethylpropyl, 1,1-dimethylpropyl, 1,2-dimethylpropyl, 1-methylpentyl, 2-methylpentyl, 3-methylpentyl, 4-methylpentyl, 1,1-dimethylbutyl, 1,2-dimethylbutyl, 1,3-dimethylbutyl, 2,2-dimethylbutyl, 2,3-dimethylbutyl, 3,3-dimethylbutyl, 1-ethylbutyl, 2-ethylbutyl, 1,1,2-trimethylpropyl, 1,2,2-trimethylpropyl, 1-ethyl-1-methylpropyl, 1-ethyl-2-methylpropyl, 1-methylhexyl, 2-methylhexyl, 3-methylhexyl, 4-methylhexyl, 5-methylhexyl, 1-ethylpentyl, 2-ethylpentyl, 3-ethylpentyl, 1-methylheptyl, 2-methylheptyl, 3-methylheptyl, 4-methylheptyl, 5-methylheptyl, 1-propylpentyl, 1-ethylhexyl, 2-ethylhexyl, 3-ethylhexyl, 1-methyloctyl, 2-methylheptyl, 1-ethylhexyl, 2-ethylhexyl, 1,2-dimethylhexyl, 1-propylpentyl, 2-propylpentyl and the like.

The term “C₁-C₁₀-alkyl” as used herein denotes a straight-chain or branched alkyl group having from 1 to 10 carbon atoms. Examples for C₁-C₁₀-alkyl are, apart those mentioned for C₁-C₄-alkyl and branched C₃-C₁₀-alkyl, n-pentyl, n-hexyl, n-heptyl, n-octyl, n-nonyl and n-decyl.

The term “C₃-C₁₀-alkanediyl” (also referred to as C₃-C₁₀-alkylene) as used herein refers to a straight-chain or branched saturated alkyl group having 3 to 10 carbon atoms, where one of the hydrogen atoms in these groups is replaced by a further bonding position. Examples for linear C₃-C₆-alkanediyl are, propane-1,3-diyl, butane-1,4-diyl, pentane-1,5-diyl, hexane-1,6-diyl. Examples for branched C₃-C₆-alkanediyl comprise propyl-1,1-diyl, butyl-1,1-diyl, 1-methylethane-1,2-diyl, 1,2-dimethylethane-1,2-diyl, 1-ethylethane-1,2-diyl, 1-methylpropane-1,3-diyl, 2-methylpropan-1,3-diyl and the like.

The term “C₃-C₁₂-cycloalkyl” as used herein refers to a mono- or bi- or tricyclic hydrocarbon radical having 3 to 12 (═C₃-C₁₂-cycloalkyl), frequently 5 to 10 carbon atoms (═C₅-C₁₀-cycloalkyl). Examples of monocyclic radicals having 3 to 10 carbon atoms comprise cyclopropyl, cyclobutyl, cyclopentyl, cyclohexyl, cycloheptyl, cyclooctyl, cyclononyl and cyclodecyl. Examples of bicyclic radicals having 7 to 8 carbon atoms comprise bicyclo[2.2.1]hexyl, bicyclo[2.2.1]heptyl, bicyclo[3.1.1]heptyl, bicyclo[2.2.2]octyl and bicyclo[3.2.1]octyl. Examples of tricyclic radicals comprise 1-adamantyl, 2-adamamantyl and homoadamantyl. C₃-C₁₂-cycloalkyl can be unsubstituted or substituted by one or more, e.g., 1, 2 or 3, identical or different radicals R^{a}, where R^{a} is selected from C₁-C₁₀-alkyl or halogen.

The term “C₅-C₈-cycloalkylene” (also referred to as C₅-C₈-cycloalkanediyl) as used herein in each case denotes a cycloalkyl radical as defined above, wherein one hydrogen atom of the cycloalkyl ring is replaced by one further binding site, thus forming a bivalent moiety. C₅-C₈-cycloalkylene can be unsubstituted or substituted by one or more, e.g., 1, 2 or 3, identical or different radicals R^{b}, where R^{b} is selected from C₁-C₁₀-alkyl or halogen.

The term “Cₙ-Cₘ-cycloalkyl-Cₒ-Cₚ-alkyl” or as used herein refers to a cycloalkyl group, as defined above, having n to m carbon atoms, which is bound to the remainder of the molecule via an alkylene group, as defined above, having o to p carbon atoms. Examples are cyclopentylmethyl, cyclopentylethyl, cyclopentylpropyl, cyclohexylmethyl, cyclohexylethyl, cyclohexylpropyl, and the like. In case that Cₙ-Cₘ-cycloalkyl-Cₒ-Cₚ-alkyl is substituted, the cycloalkyl moiety carries one or more, e.g., 1, 2 or 3, identical or different radicals R^{a}, where R^{a} is selected from C₁-C₁₀-alkyl or halogen.

The term “aryl” as used herein refers to a C₆-C₁₄-carboaromatic group, such as phenyl, naphthyl, anthracenyl and phenanthrenyl. Aryl can be unsubstituted or substituted by one or more, e.g., 1, 2 or 3, identical or different radicals R^{a}, where R^{a} is selected from C₁-C₁₀-alkyl or halogen. Preferably, aryl is phenyl.

The term “arylene” as used herein refers to an aryl radical as defined above, wherein one hydrogen atom at any position of aryl is replaced by one further binding site, thus forming a bivalent moiety. Arylene can be unsubstituted or substituted by one or more, e.g., 1, 2 or 3, identical or different radicals R^{b}, where R^{b} is selected from C₁-C₁₀-alkyl or halogen. Preferably, aryl is phenylene.

The term “phenylene” refers to 1,2-phenylene (o-phenylene), 1,3-phenylene (m-phenylene) and 1,4-phenylene (p-phenylene).

The term “heteroaryl” (“mono- or bicyclic 5- to 10-membered heteroaromatic ring”) as used herein refers to a monocyclic heteroaromatic radical which has 5 or 6 ring members, which may be fused to a carbocyclic or heterocyclic 5-, 6- or 7-membered ring thus having a total number of ring members from 8 to 10, wherein in each case 1, 2, 3 or 4, preferably 1, 2 or 3, of these ring members are heteroatoms selected, independently from each other, from the group consisting of oxygen, nitrogen and sulfur. The heteroaryl radical may be attached to the remainder of the molecule via a carbon ring member or via a nitrogen ring member. The carbocyclic or heterocyclic fused ring is selected from C₅-C₇-cycloalkyl, 5-, 6- or 7-membered heterocyclyl and phenyl. Heteroaryl can be unsubstituted or substituted by one or more, e.g., 1, 2 or 3, identical or different radicals R^{a}, where R^{a} is selected from C₁-C₁₀-alkyl or halogen. Preferably, aryl is phenyl.

Examples for monocyclic 5- to 6-membered heteroaromatic rings include triazinyl, pyrazinyl, pyrimidyl, pyridazinyl, pyridyl, thienyl, furyl, pyrrolyl, pyrazolyl, imidazolyl, triazolyl, tetrazolyl, thiazolyl, oxazolyl, thiadiazolyl, oxadiazolyl, isothiazolyl and isoxazolyl.

Examples for 5- to 6-membered heteroaromatic rings being fused to a phenyl ring (or for a phenyl ring fused to a 5- to 6-membered heteroaromatic ring) are quinolinyl, isoquinolinyl, indolyl, indolizinyl, isoindolyl, indazolyl, benzofuryl, benzthienyl, benzo[b]thiazolyl, benzoxazolyl, benzthiazolyl, benzoxazolyl, and benzimidazolyl. Examples for 5- to 6-membered heteroaromatic rings being fused to a cycloalkenyl ring are dihydroindolyl, dihydroindolizinyl, dihydroisoindolyl, dihydrochinolinyl, dihydroisochinolinyl, chromenyl, chromanyl and the like.

The term “heteroarylene” as used herein refers to a heteroaryl radical as defined above, wherein one hydrogen atom at any position of heteroaryl is replaced by one further binding site, thus forming a bivalent moiety. Heteroarylene can be unsubstituted or substituted by one or more, e.g., 1, 2 or 3, identical or different radicals R^{b}, where R^{b} is selected from C₁-C₁₀-alkyl or halogen.

The term “heterocyclyl” comprises nonaromatic saturated or partially unsaturated heterocyclic rings having 5 or 6 ring members and 1, 2, 3 or 4, preferably 1, 2 or 3 heteroatoms as ring members. The heterocyclic radical may be attached to the remainder of the molecule via a carbon ring member or via a nitrogen ring member. Examples for non-aromatic rings include pyrrolidinyl, pyrazolinyl, imidazolinyl, pyrrolinyl, pyrazolinyl, imidazolinyl, tetrahydrofuranyl, dihydrofuranyl, 1,3-dioxolanyl, dioxolenyl, thiolanyl, dihydrothienyl, oxazolidinyl, isoxazolidinyl, oxazolinyl, isoxazolinyl, thiazolinyl, isothiazolinyl, thiazolidinyl, isothiazolidinyl, oxathiolanyl, piperidinyl, piperazinyl, pyranyl, dihydropyranyl, tetrahydropyranyl, 1,3- and 1,4-dioxanyl, thiopyranyl, dihydrothiopyranyl, tetrahydrothiopyranyl, morpholinyl, thiazinyl and the like. Examples for heterocyclic ring also comprising 1 or 2 carbonyl groups as ring members comprise pyrrolidin-2-onyl, pyrrolidin-2,5-dionyl, imidazolidin-2-onyl, oxazolidin-2-onyl, thiazolidin-2-onyl and the like. Heterocyclyl can be unsubstituted or substituted by one or more, e.g., 1, 2 or 3, identical or different radicals R^{a}, where R^{a} is selected from C₁-C₁₀-alkyl or halogen. Preferably, aryl is phenyl.

The term “halogen” denotes fluorine, chlorine, bromine or iodine.

Depending on the substitution pattern, the compounds of the formula I used according to the present invention may have one or more centers of chirality, in which case they are present as mixtures of enantiomers or diastereomers. The present invention provides the use according to the invention of the pure enantiomers or diastereomers of the compounds I or their mixtures.

Polyamide polymers are herein to be understood as being homopolymers, copolymers, blends and grafts of synthetic long-chain polyamides having recurring amide groups in the polymer main chain as an essential constituent.

Examples of polyamide homopolymers are nylon-6 (PA 6, polycaprolactam), nylon-7 (PA 7, polyenantholactam or polyheptanoamide), nylon-10 (PA 10, polydecanoamide), nylon-11 (PA 11, polyundecanolactam), nylon-12 (PA 12, polydodecanolactam), nylon-4,6 (PA 46, polytetramethyleneadipamide), nylon-6,6 (PA 66, polyhexamethylene-adipamide), nylon-6,9 (PA 69, polycondensation product of 1,6-hexamethylenediamine and azelaic acid), nylon-6,10 (PA 610, polycondensation product of 1,6-hexamethylene diamine and 1,10-decanedioic acid), nylon-6,12 (PA 612, polycondensation product of 1,6-hexamethylenediamine and 1,12-dodecanedioic acid), nylon 10,10 (PA 1010, polycondensation product of 1,10-decamethylenediamine and 1,10-decanedicarboxylic acid), PA 1012 (polycondensation product of 1,10-decamethylenediamine and dodecanedicarboxylic acid) or PA 1212 (polycondensation product of 1,12-dodecamethylenediamine and dodecanedicarboxylic acid).

Polyamide copolymers may comprise the polyamide building blocks in various ratios. Examples of polyamide copolymers are nylon 6/66 and nylon 66/6 (PA 6/66, PA 66/6, copolyamides made from PA 6 and PA 66 building blocks, i.e. made from caprolactam, hexamethylenediamine and adipic acid). PA 66/6 (90/10) may contain 90% of PA 66 and 10% of PA 6. Further examples are nylon 66/610 (PA 66/610, made from hexamethylenediamine, adipic acid and sebacic acid).

Polyamides further include partially aromatic polyamides. The partially aromatic polyamides are usually derived from aromatic dicarboxylic acids such as terephthalic acid or isophthalic acid and a linear or branched aliphatic diamine. Examples are PA 9T (formed from terephthalic acid and nonanediamine), PA 6T/6I (formed from hexamethylenediamine, terephthalic acid and isophthalic acid), PA 6T/6, PA 6T/61/66 and PA 6T/66.

Polyamides further include aromatic polyamides such as poly-meta-phenylene-isophathalamides (Nomex®) or poly-para-phenylene-terephthalamide (Kevlar®).

Polyamides can in principle be prepared by two methods. In a polymerization from dicarboxylic acids and diamines and also in a polymerization from amino acids or their derivatives, such as aminocarbonitriles, aminocarboxamides, aminocarboxylate esters or aminocarboxylate salts, the amino and carboxyl end groups of the starting monomers or starting oligomers react with one another to form an amide group and water. The water can subsequently be removed from the polymer. In a polymerization from carboxamides, the amino and amide end groups of the starting monomers or starting oligomers react with one another to form an amide group and ammonia. The ammonia can subsequently be removed from the polymer. This polymerization reaction is customarily known as a polycondensation.

A polymerization from lactams as starting monomers or starting oligomers is customarily known as a polyaddition.

Polyamides further include copolymers made of polyamides and of a further segment, for example taking the form of a diol, polyester, ether, etc., in particular in the form of polyesteramides, polyetheresteramides or polyetheramides. For example, in polyetheramides, the polyamide segment can be any commercial available polyamide, preferably PA 6 or PA 66 and the polyether is usually polyethylene glycol, polypropylene glycol or polytetramethylene glycol.

The polyamide is preferably a semi-crystalline polyamide which is selected from aliphatic polyamides, partially aromatic polyamides and mixtures thereof. According to a particular aspect, the polyamide resin is selected from PA 6, PA 7, PA 10, PA 11, PA 12, PA 66, PA 69, PA 610, PA 612, PA 1010, PA 6/66, PA 66/6, PA 66/610 and mixtures thereof. According to a more particular aspect, the polyamide is selected from PA 6, PA 11, PA 12, PA 66, PA 610, PA 66/6 and PA 6/66. In particular, the polyamide is PA 6.

The remarks made below as to preferred embodiments of the variables (substituents) and indices of the compounds of formula I are valid on their own as well as preferably in combination with each other. It is clear to a skilled person that for x being 2 or 3, Z may be identical or different.

An embodiment of the invention relates to uses and methods, where in the compound of formula I the variables R¹, R², Z and x each alone or in combination have the following meanings:
x is 1, 2 or 3;
R¹ and R² are, independently of each other, selected from linear C₁-C₇-alkyl, branched C₃-C₁₀-alkyl, unsubstituted or substituted C₃-C₁₂-cycloalkyl, unsubstituted or substituted C₃-C₁₂-cycloalkyl-C₁-C₄-alkyl, unsubstituted or substituted aryl and unsubstituted or substituted aryl-C₁-C₄-alkyl; and
Z is selected from C₃-C₁₀-alkanediyl, unsubstituted or substituted arylene, unsubstituted or substituted arylene-C₁-C₄-alkylene-arylene, unsubstituted or substituted heteroarylene, unsubstituted or substituted heteroarylene-C₁-C₄-alkylene-heteroarylene, unsubstituted or substituted C₅-C₈-cycloalkylene, unsubstituted or substituted C₅-C₈-cycloalkylene-C₁-C₄alkylene-C₅-C₈-cycloalkylene, unsubstituted or substituted heterocycloalkylene and unsubstituted or substituted heterocycloalkylene-C₁-C₄-alkylene-heterocycloalkylene.

A preferred embodiment of the invention relates to uses and methods, where in the compound of formula I the variables R¹, R², Z and x each alone or in combination have the following meanings:
x is 1, 2 or 3, preferably 1 or 2, in particular 1;
R¹ and R² are, independently of each other, selected from hydrogen, branched C₃-C₁₀-alkyl, C₅-C₁₂-cycloalkyl, C₅-C₁₂-cycloalkyl, C₅-C₁₂-cycloalkyl-C₁-C₄-alkyl, aryl and aryl-C₁-C₄-alkyl, where each ring in the four last-mentioned radicals is unsubstituted or substituted by one or more identical or different radicals R^{a}, where R^{a} is selected from C₁-C₁₀-alkyl and halogen.
   More preferably, R¹ and R² are, independently of each other, selected from hydrogen, branched C₃-C₁₀-alkyl, C₅-C₁₂-cycloalkyl, C₅-C₁₂-cycloalkyl, C₅-C₁₂-cycloalkyl-C₁-C₄-alkyl, phenyl and phenyl-C₁-C₄-alkyl, where each ring in the four last-mentioned radicals is unsubstituted or substituted by one or more identical or different radicals R^{a}, where R^{a} is selected from C₁-C₁₀-alkyl and halogen.
   In particular, R¹ and R² are, independently of each other, selected from hydrogen, branched C₃-C₁₀-alkyl, which is attached to the skeleton via a secondary or tertiary carbon atom of the alkyl group, C₅-C₁₀-cycloalkyl which is unsubstituted or substituted by 1 or 2 radicals R^{a}, and phenyl which is unsubstituted or substituted by 1 or 2 radicals R^{a}.
   Suitable examples for R¹ and R² are hydrogen, ethyl, n-propyl, isopropyl, n-butyl, tert-butyl, 1-methylpropyl, 1-ethylpropyl, 1,1-dimethylpropyl, 2-methylbutyl, 1,5-dimethylhexyl, 1,1,3,3-tetramethylbutyl, 1-adamantyl, 2-adamamantyl, homoadamantyl, cyclopentyl, cyclohexyl, cyclopentylmethyl, 1-cyclopentylethyl, 2-cyclopentylethyl, cyclohexylmethyl, 1-cyclohexylethyl, 2-cyclohexylethyl, cyclopentyl which is substituted by 1 or 2 C₁-C₄-alkyl, cyclohexyl which is substituted by 1 or 2 C₁-C₄-alkyl, phenyl, tolyl or 3,4-dimethylphenyl. In particular, R¹ and R² are selected from hydrogen, isopropyl, tert-butyl, 1-methylpropyl, 1-ethylpropyl, 1,1-dimethylpropyl, 2-methylbutyl, 1,5-dimethylhexyl, 1,1,3,3-tetramethylbutyl and 1-adamantyl.
Z is C₅-C₈-alkylene, C₅-C₇-cycloalkylene, C₅-C₇-cycloalkylene-CH₂-C₅-C₇-cycloalkylene, phenylene or phenylen-CH₂-phenylene, where each ring in the four last-mentioned radicals is unsubstituted or substituted by one or two identical or different radicals R^{b}, where R^{b} is C₁-C₁₀-alkyl or halogen
   Z is preferably 1,5-pentanediyl, 1,6-hexanediyl, 1,7-heptanediyl, cis 1,2-cyclopentanediyl, trans 1,2-cyclopentanediyl, c is 1,3-cyclopentanediyl, trans 1,3-cyclopentanediyl, where the 4 last mentioned radicals are unsubstituted or carry 1 or 2 C₁-C₄-alkyl groups, c is 1,2-cyclohexanediyl, trans 1,2-cyclohexanediyl, c is 1,3-cyclohexanediyl, trans 1,3-cyclohexanediyl, c is 1,4-cyclohexanediyl, trans 1,4-cyclohexanediyl, where the 6 last-mentioned groups are unsubstituted or carry 1 or 2 C₁-C₄-alkyl groups, 1,2-phenylene, 1,3-phenylene, 1,4-phenylene, where the 3 last-mentioned groups are unsubstituted or carry 1 or 2 C₁-C₄-alkyl groups;

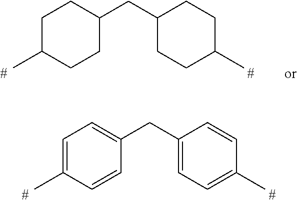

where # is the point of attachment to the internal nitrogen atom in the urea moiety;
In particular, Z is trans-1,4-cyclohexanediyl. In particular, if x is 2, each Z has the same meaning.

A preferred embodiment of the invention relates to uses and methods, where in the compound of formula I R¹ and R² have different meanings. A further preferred embodiment of the invention relates to uses and methods, where in the compound of formula I, R¹ and R² have the same meaning.

A particularly preferred embodiment of the invention relates to uses and methods, where in the compound of formula I the variables R¹, R², Z and x have the following meanings:
R¹ and R² have the same meaning and are selected from 1,1-dimethylpropyl, 1,5-dimethylhexyl, 1,1,3,3-tetramethylbutyl and 1-adamantyl;
Z is trans 1,4-cyclohexandiyl; and
x is 1.

A further particularly preferred embodiment of the invention relates to uses and methods, where in the compound of formula I the variables R¹ and R² are both hydrogen, Z is trans 1,4-cyclohexandiyl and x is 1.

A particularly preferred embodiment of the invention relates to uses and methods, where the polyamide resin is selected from PA 6, PA 11, PA 12, PA 66, PA 610, PA 66/6 and PA 6/66 and in the compound of formula I R¹ and R² are identical and selected from tert-butyl, 1,1-dimethylpropyl, 1,5-dimethylhexyl, 1,1,3,3-tetramethylbutyl and 1-adamantyl; Z is trans 1,4-cyclohexylene; and x is 1.

A further particularly embodiment of the invention relates to uses and methods, where the polyamide resin is selected from PA 6, PA 11, PA 12, PA 66, PA 610, PA 66/6 and PA 6/66 and in the compound of formula I R¹ and R² are both hydrogen; Z is trans 1,4-cyclohexylene; and x is 1.

The compounds of the formula I are either known in the art or can be prepared in analogy to standard methods in the art or as outlined in the experimental part of this application.

Compounds of the formula I, where x is 1, are also referred to as bisurea compounds I. Compounds of the formula I, where x is 2, are also referred to as trisurea compounds I. Compounds of the formula I, where x is 3, are also referred to as tetra-urea compounds

For example, compounds of the formula I, where x is 1 and R¹ and R² have the same meaning can be prepared as outlined in schemes 1 and 2 below.

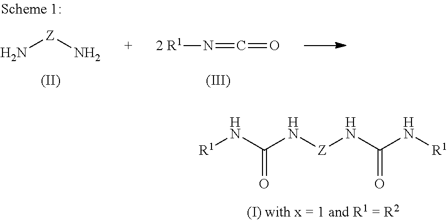

In Scheme 1, Z and R¹ are as defined. A diamine compound of the formula II is reacted with two equivalents of isocyanate III to yield the compound of the formula I in good yields. The reaction is usually carried out in an organic solvent. Suitable solvents are polar aprotic solvents such as tetrahydrofuran.

Alternatively, the bisurea compounds of the formula I can be prepared by reacting a diisocyanate compound of the formula IV with an amine of the formula V. The reaction is usually carried out in an organic solvent. Suitable solvents are polar aprotic solvents such as tetrahydrofuran.

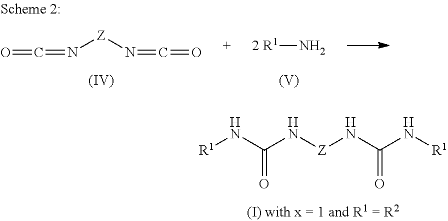

In Scheme 2, Z and R¹ are as defined above.

Compounds of the formula I, where x is 1 and R¹ and R² have different meaning can be prepared as outlined in scheme 3 below.

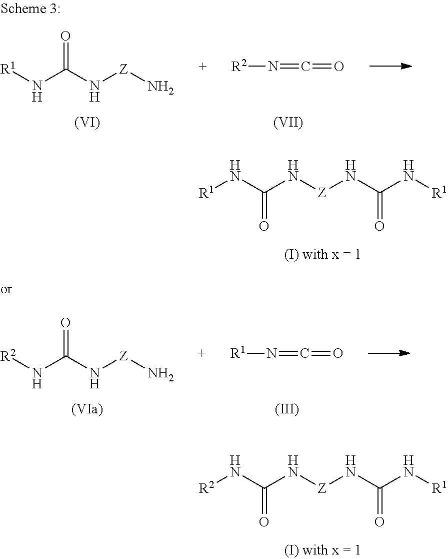

In Scheme 3, Z, R¹ and R² are as defined above. Treatment of an amine compound of the formula VI and VIa, respectively, with an isocyanate VII and III, respectively, yields the compound of the formula I in good yields. The reaction is usually carried out in an organic solvent. Suitable solvents are polar aprotic solvents such as N-methylpyrrolidon.

Trisurea-compounds of the formula I, i.e. compounds of the formula I, where x is 2 and R¹ has the same meaning as R², can be prepared as outlined in scheme 4.

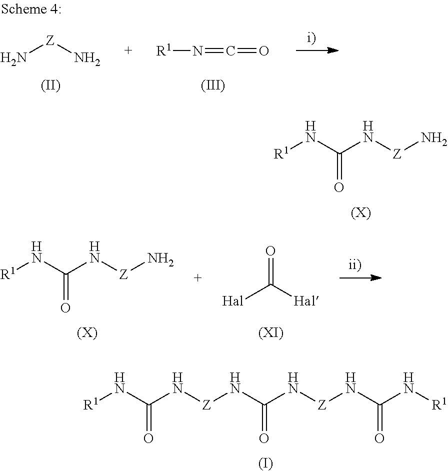

In Scheme 4, Z and R¹ are as defined above. Hal is halogen, Hal′ is halogen. Preferably, Hal and Hal′ are chlorine.

In step i) of scheme 4, the diamine II is reacted with one equivalent of isocyanate III to give an amine compound X. The reaction can be carried out in analogy to the procedure described in schemel. In step ii) of scheme 4, the amine compound X is reacted with a carbonyl dihalide of the formula XI to give the trisurea compound I.

Trisurea-compounds of the formula I, i.e. compounds of the formula I, where x is 2, and R¹ has the same meaning as R², can be prepared as outlined in scheme 5.

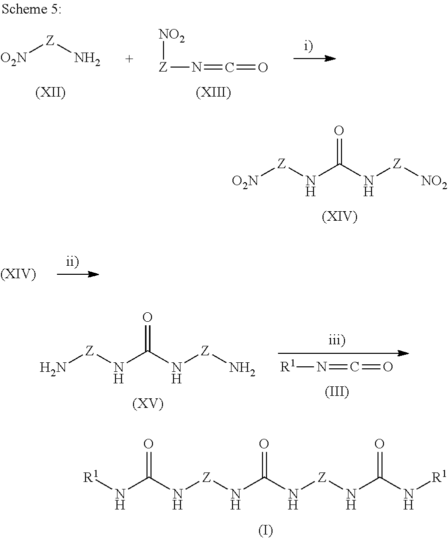

In Scheme 5, R¹ is as defined above and Z is as defined above, preferably cycloalkylene or arylene.

In step i) of scheme 5, the amine compound XII is reacted with the isocyanate compound XIII to give the dinitro compound XIV. The reaction can be carried out in analogy to the method described in step i) of scheme 4. In step ii) of scheme 5, the dinitro compound XIV is reduced to the diamino compound XV. The reduction can be carried out with hydrazine hydrate in the presence of a Pd/C catalyst. In step iii) of scheme 5, the reaction between the diamino compound XV and 2 equivalents of the isocyanate compound III yields the trisurea compound I.

Tetra-urea-compounds of the formula I, i.e. compounds of the formula I, where x is 3, and R¹ has the same meaning as R², can be prepared as outlined in scheme 6.

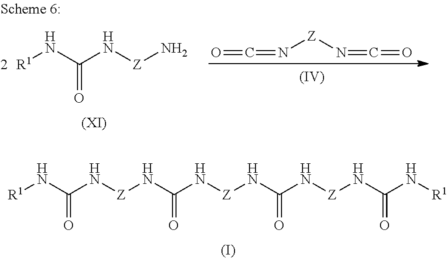

In Scheme 6, R¹ and Z are as defined above. R¹ may have identical or different meanings. Z may have identical or different meanings. The amino compound XI is reacted with a diisocyanate compound IV in analogy to the procedure described in scheme 2.

The polyamide resins often contain one or more further components, e.g. selected from colorants, antioxidants, UV-absorber, light stabilizers, reinforcing materials, fillers, antifogging agents, mold release agents, biocides, antistatic agents and rheology modifier. Examples for additional components which may be contained in the composition of the invention include the following:

1. Colorants

The term colorant comprises dyes and pigments. The pigment may be an organic or inorganic pigment as known in the art. Examples for suitable pigments are color pigments, pearlescent pigments, e.g. effect pigments or pigments based on liquid crystal polymers.

The colorant can be a dye. Likewise regarded as colorants are organic compounds which exhibit fluorescence in the visible part of the electromagnetic spectrum, such as fluorescent dyes or fluorescent whitening agents. The colorant may also have further properties such as electrical conductivity, or may be magnetically shielding.

Suitable dyes are all dyes which are soluble in the polyamide polymer composition. Examples of suitable dyes are azo dyes, pyrazolone dyes, anthraquinone dyes, perinone dyes, perylene dyes, indigo and thioindigo dyes, and azomethine dyes.

2. Antioxidants

2.1. Alkylated monophenols, for example 2,6-di-tert-butyl-4-methylphenol, 2-tert-butyl-4,6-dimethylphenol, 2,6-di-tert-butyl-4-ethylphenol, 2,6-di-tert-butyl-4-n-butylphenol, 2,6-di-tert-butyl-4-isobutylphenol, 2,6-dicyclopentyl-4-methylphenol, 2-α-methylcyclohexyl)-4,6-dimethylphenol, 2,6-dioctadecyl-4-methylphenol, 2,4,6-tricyclohexylphenol, 2,6-di-tert-butyl-4-methoxymethylphenol, nonylphenols which are linear or branched in the side chains, for example 2,6-di-nonyl-4-methylphenol, 2,4-dimethyl-6-(1′-methylundec-1′-yl)phenol, 2,4-dimethyl-6-(1′-methylheptadec-1′-yl)phenol, 2,4-dimethyl-6-(1′-methyltridec-1′-yl)phenol and mixtures thereof.

2.2. Alkylthiomethylphenols, for example 2,4-dioctylthiomethyl-6-tert-butylphenol, 2,4-dioctylthiomethyl-6-methylphenol, 2,4-dioctylthiomethyl-6-ethylphenol, 2,6-di-dodecylthiomethyl-4-nonylphenol.

2. 3. Hydroquinones and alkylated hydroquinones, for example 2,6-di-tert-butyl-4-methoxyphenol, 2,5-di-tert-butylhydroquinone, 2,5-di-tert-amylhydroquinone, 2,6-diphenyl-4-octadecyloxyphenol, 2,6-di-tert-butylhydroquinone, 2,5-di-tert-butyl-4-hydroxyanisole, 3,5-di-tert-butyl-4-hydroxyanisole, 3,5-di-tert-butyl-4-hydroxyphenyl stearate, bis(3,5-di-tert-butyl-4-hydroxyphenyl)adipate.

2.4. Tocopherols, for example α-tocopherol, β-tocopherol, γ-tocopherol, δ-tocopherol and mixtures thereof (vitamin E).

2.5. Hydroxylated thiodiphenyl ethers, for example 2,2′-thiobis(6-tert-butyl-4-methylphenol), 2,2′-thiobis(4-octylphenol), 4,4′-thiobis-(6-tert-butyl-3-methylphenol), 4,4′-thiobis(6-tert-butyl-2-methylphenol), 4,4′-thiobis(3,6-di-sec-amylphenol), 4,4′-bis(2,6-dimethyl-4-hydroxyphenyl)disulfide.

2.6. Alkylidenebisphenols, for example 2,2′-methylenebis(6-tert-butyl-4-methylphenol), 2,2′-methylenebis(6-tert-butyl-4-ethylphenol), 2,2′-methylenebis[4-methyl-6α-methylcyclohexyl)-phenol], 2,2′-methylenebis(4-methyl-6-cyclohexylphenol), 2,2′-methylenebis(6-nonyl-4-methylphenol), 2,2′-methylenebis(4,6-di-tert-butylphenol), 2,2′-ethylidenebis(4,6-di-tert-butylphenol), 2,2′-ethylidenebis(6-tert-butyl-4-isobutylphenol), 2,2′-methylenebis[6-(α-methylbenzyl)-4-nonylphenol], 2,2′-methylenebis[6-(α,α-dimethylbenzyl)-4-nonylphenol], 4,4′-methylenebis(2,6-di-tert-butylphenol), 4,4′-methylenebis(6-tert-butyl-2-methylphenol), 1,1-bis(5-tert-butyl-4-hydroxy-2-methylphenyl)butane, 2,6-bis(3-tert-butyl-5-methyl-2-hydroxybenzyl)-4-methylphenol, 1,1,3-tris(5-tert-butyl-4-hydroxy-2-methylphenyl)butane, 1,1-bis(5-tert-butyl-4-hydroxy-2-methylphenyl)-3-n-dodecylmercaptobutane, ethyleneglycolbis[3,3-bis(3′-tertbutyl-4′-hydroxyphenyl)butyrate], bis(3-tert-butyl-4-hydroxy-5-methyl-phenyl)dicyclopentadiene, bis[2-(3′-tert-butyl-2′-hydroxy-5′-methylbenzyl)-6-tert-butyl-4-methylphenyl]terephthalate, 1,1-bis-(3,5-dimethyl-2-hydroxyphenyl)butane, 2,2-bis(3,5-di-tert-butyl-4-hydroxyphenyl)propane, 2,2-bis-(5-tert-butyl-4-hydroxy-2-methylphenyl)-4-n-dodecylmercaptobutane, 1,1,5,5-tetra(5-tert-butyl-4-hydroxy-2-methylphenyl)pentane.

2.7. O-, N- and S-benzyl compounds, for example 3,5,3′,5′-tetra-tert-butyl-4,4′-dihydroxydibenzylether, octadecyl-4-hydroxy-3,5-dimethylbenzylmercaptoacetate, tridecyl-4-hydroxy-3,5-di-tert-butylbenzylmercaptoacetate, tris(3,5-di-tert-butyl-4-hydroxybenzyl)amine, bis(4-tert-butyl-3-hydroxy-2,6-dimethylbenzyl)dithioterephthalate, bis(3,5-di-tert-butyl-4-hydroxybenzyl)sulfide, isooctyl-3,5-di-tert-butyl-4-hydroxybenzylmercaptoacetate.

2.8. Hydroxybenzylated malonates, for example dioctadecyl-2,2-bis(3,5-di-tert-butyl-2-hydroxybenzyl)malonate, di-octadecyl-2-(3-tert-butyl-4-hydroxy-5-methylbenzyl)malonate, didodecylmercaptoethyl-2,2-bis(3,5-di-tert-butyl-4-hydroxybenzyl)malonate, bis[4-(1,1,3,3-tetramethylbutyl)phenyl]-2,2-bis(3,5-di-tert-butyl-4-hydroxybenzyl)malonate.

2.9. Aromatic hydroxybenzyl compounds, for example 1,3,5-tris(3,5-di-tert-butyl-4-hydroxybenzyl)-2,4,6-trimethylbenzene, 1,4-bis(3,5-di-tert-butyl-4-hydroxybenzyl)-2,3,5,6-tetramethylbenzene, 2,4,6-tris(3,5-di-tert-butyl-4-hydroxybenzyl)phenol.

2.10. Triazine compounds, for example 2,4-bis(octylmercapto)-6-(3,5-di-tert-butyl-4-hydroxyanilino)-1,3,5-triazine, 2-octylmercapto-4,6-bis(3,5-di-tert-butyl-4-hydroxyanilino)-1,3,5-triazine, 2-octylmercapto-4,6-bis(3,5-di-tert-butyl-4-hydroxyphenoxy)-1,3,5-triazine, 2,4,6-tris(3,5-di-tert-butyl-4-hydroxyphenoxy)-1,2,3-triazine, 1,3,5-tris(3,5-di-tert-butyl-4-hydroxybenzyl)isocyanurate, 1,3,5-tris(4-tert-butyl-3-hydroxy-2,6-dimethylbenzyl)isocyanurate, 2,4,6-tris(3,5-di-tert-butyl-4-hydroxyphenylethyl)-1,3,5-triazine, 1,3,5-tris(3,5-di-tert-butyl-4-hydroxyphenylpropionyl)hexahydro-1,3,5-triazine, 1,3,5-tris(3,5-dicyclohexyl-4-hydroxybenzyl)isocyanurate.

2.11. Benzylphosphonates, for example dimethyl-2,5-di-tert-butyl-4-hydroxybenzylphosphonate, diethyl-3,5-di-tert-butyl-4-hydroxybenzylphosphonate, dioctadecyl-3,5-di-tert-butyl-4-hydroxybenzylphosphonate, dioctadecyl-5-tert-butyl-4-hydroxy-3-methylbenzylphosphonate, the calcium salt of the monoethyl ester of 3,5-di-tert-butyl-4-hydroxybenzylphosphonic acid.

2.12. Acylaminophenols, for example 4-hydroxylauranilide, 4-hydroxystearanilide, octyl N-(3,5-di-tert-butyl-4-hydroxyphenyl)carbamate.

2.13. Esters of β-(3,5-di-tert-butyl-4-hydroxyphenyl)propionic acid with mono- or polyhydric alcohols, e.g. with methanol, ethanol, n-octanol, isooctanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxyethyl)isocyanurate, N,N′-bis(hydroxyethyl)oxamide, 3-thiaundecanol, 3-thiapentadecanol, trimethylhexanediol, trimethylolpropane, 4-hydroxymethyl-1-phospha-2,6,7-trioxabicyclo[2.2.2]octane.

2.14. Esters of β-(5-tert-butyl-4-hydroxy-3-methylphenyl)propionic acid with mono- or polyhydric alcohols, e.g. with methanol, ethanol, n-octanol, isooctanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxyethyl)isocyanurate, N,N′-bis(hydroxyethyl)oxamide, 3-thiaundecanol, 3-thiapentadecanol, trimethylhexanediol, trimethylpropane, 4-hydroxymethyl-1-phospha-2,6,7-trioxabicyclo[2.2.2]octane; 3,9-bis[2-{3-(3-tert-butyl-4-hydroxy-5-methylphenyl)propionyloxy}-1,1-dimethylethyl]-2,4,8,10-tetraoxaspiro[5.5]-undecane.

2.15. Esters of β-(3,5-dicyclohexyl-4-hydroxyphenyl)propionic acid with mono- or polyhydric alcohols, e.g. with methanol, ethanol, octanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxyethyl)isocyanurate, N,N′-bis(hydroxyethyl)oxamide, 3-thiaundecanol, 3-thiapentadecanol, trimethylhexanediol, trimethylolpropane, 4-hydroxymethyl-1-phospha-2,6,7-trioxabicyclo[2.2.2]octane.

2.16. Esters of 3,5-di-tert-butyl-4-hydroxyphenyl acetic acid with mono- or polyhydric alcohols, e.g. with methanol, ethanol, octanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxyethyl)isocyanurate, N,N′-bis(hydroxyethyl)oxamide, 3-thiaundecanol, 3-thiapentadecanol, trimethylhexanediol, trimethylolpropane, 4-hydroxymethyl-1-phospha-2,6,7-trioxabicyclo[2.2.2]octane.

2.17. Amides of β-(3,5-di-tert-butyl-4-hydroxyphenyl)propionic acid e.g. N,N′-bis(3,5-di-tert-butyl-4-hydroxyphenylpropionyl)hexamethylenediamide, N,N′-bis(3,5-di-tert-butyl-4-hydroxyphenylpropionyl)trimethylenediamide, N,N′-bis(3,5-di-tert-butyl-4-hydroxyphenylpropionyl)hydrazide, N,N′-bis[2-(3-[3,5-di-tert-butyl-4-hydroxyphenyl]propionyloxy)ethyl]oxamide(Naugard™ XL-1, supplied by Uniroyal).

2.18. Ascorbic acid (vitamin C)

2.19. Aminic antioxidants, for example N,N′-diisopropyl-p-phenylenediamine, N,N′-di-sec-butyl-p-phenylenediamine, N,N′-bis(1,4-dimethylpentyl)-p-phenylenediamine, N,N′-bis(1-ethyl-3-methylpentyl)-p-phenylenediamine, N,N′-bis(1-methylheptyl)-p-phenylenediamine, N,N′-dicyclohexyl-p-phenylenediamine, N,N′-diphenyl-p-phenylenediannine, N,N′-bis(2-naphthyl)-p-phenylenediamine, N-isopropyl-N′-phenyl-p-phenylenediamine, N-(1,3-dimethylbutyl)-N′-phenyl-p-phenylenediamine, N-(1-methylheptyl)-N′-phenyl-p-phenylenediamine, N-cyclohexyl-N′-phenyl-p-phenylenediamine, 4-(p-toluenesulfamoyl)diphenylamine, N,N′-dimethyl-N,N′-di-sec-butyl-p-phenylenediannine, diphenylamine, N-allyldiphenylamine, 4-isopropoxydiphenyl-amine, N-phenyl-1-naphthylamine, N-(4-tert-octylphenyl)-1-naphthylamine, N-phenyl-2-naphthylamine, octylated diphenylamine, for example p,p′-di-tert-octyldiphenylamine, 4-n-butyl-aminophenol, 4-butyrylaminophenol, 4-nonanoylaminophenol, 4-dodecanoylaminophenol, 4-octadecanoylaminophenol, bis(4-methoxyphenyl)amine, 2,6-di-tert-butyl-4-dimethylaminomethylphenol, 2,4′-diaminodiphenylmethane, 4,4′-diaminodiphenylmethane, N,N,N′,N′-tetramethyl-4,4′-diaminodiphenylmethane, 1,2-bis[(2-methylphenyl)amino]ethane, 1,2-bis(phenylamino)propane, (o-tolyl)biguanide, bis[4-(1′,3′-dimethylbutyl)phenyl]amine, tert-octylated N-phenyl-1-naphthylamine, a mixture of mono- and dialkylated tert-butyl/tert-octyldiphenylamines, a mixture of mono- and dialkylated nonyldiphenylamines, a mixture of mono- and dialkylated dodecyldiphenylamines, a mixture of mono- and dialkylated isopropyl/isohexyl-diphenylamines, a mixture of mono- and dialkylated tert-butyldiphenylamines, 2,3-dihydro-3,3-dimethyl-4H-1,4-benzothiazine, phenothiazine, a mixture of mono- and dialkylated tert-butyl/tert-octylphenothiazines, a mixture of mono- and dialkylated tert-octylphenothiazines, N-allylphenothiazine, N,N,N′,N′-tetraphenyl-1,4-diaminobut-2-ene, N,N-bis(2,2,6,6-tetramethylpiperid-4-yl)-hexamethylenediamine, bis(2,2,6,6-tetramethylpiperid-4-yl)sebacate, 2,2,6,6-tetramethylpiperidin-4-one, 2,2,6,6-tetramethylpiperidin-4-ol.

3. UV Absorbers and Light Stabilisers

3.1. 2-(2′-Hydroxyphenyl)benzotriazoles, for example 2-(2′-hydroxy-5′-methylphenyl)benztriazole, 2-(3′,5′-di-tert-butyl-2′-hydroxyphenyl)benzotriazole, 2-(5′-tert-butyl-2′-hydroxyphenyl)benzotriazole, 2-(2′-hydroxy-5′-(1,1,3,3-tetramethylbutyl)phenyl)benzotriazole, 2-(3′,5′-di-tert-butyl-2′-hydroxyphenyl)-5-chlorobenzotriazole, 2-(3′-tert-butyl-2′-hydroxy-5′-methylphenyl)-5-chlorobenzotriazole, 2-(3′-sec-butyl-5′-tert-butyl-2′-hydroxyphenyl)benzotriazole, 2-(2′-hydroxy-4′-octyloxyphenyl)benzotriazole, 2-(3′,5′-di-tert-amyl-2′-hydroxyphenyl)benzotriazole, 2-(3′,5′-bis(α,α-dimethylbenzyl)-2′-hydroxyphenyl)benzotriazole, 2-(3′-tert-butyl-2′-hydroxy-5′-(2-octyloxycarbonylethyl)phenyl)-5-chlorobenzotriazole, 2-(3′-tert-butyl-5′-[2-(2-ethylhexyloxy)carbonylethyl]-2′-hydroxyphenyl)-5-chlorobenzotriazole, 2-(3′-tert-butyl-2′-hydroxy-5′-(2-methoxycarbonylethyl)phenyl)-5-chlorobenzotriazole, 2-(3′-tert-butyl-2′-hydroxy-5′-(2-methoxycarbonylethyl)phenyl)benzotriazole, 2-(3′-tert-butyl-2′-hydroxy-5′-(2-octyloxycarbonylethyl)phenyl)benzotriazole, 2-(3′-tert-butyl-5′-[2-(2-ethylhexyloxy)carbonylethyl]-2′-hydroxyphenyl)benzotriazole, 2-(3′-dodecyl-2′-hydroxy-5′-methylphenyl)benzotriazole, 2-(3′-tert-butyl-2′-hydroxy-5′-(2-isooctyloxycarbonylethyl)phenylbenzotriazole, 2,′-methylenebis[4-(1,1,3,3-tetramethylbutyl)-6-benzotriazole-2-yl-phenol] the transesterification product of 2-[3′-tert-butyl-5′-(2-methoxycarbonylethyl)-2′-hydroxyphenyl]-2H-benzotriazole with polyethylene glycol 300; [R—CH₂CH₂—COO—CH₂CH₂]₂, where R=3′-tert-butyl-4′-hydroxy-5′-2H-benzotriazol-2-yl-phenyl, 2-[2′-hydroxy-3′-(α,α-dimethylbenzyl)-5′-(1,1,3,3-tetramethylbutyl)phenyl]benzotriazole; 2-[2′-hydroxy-3′-(1,1,3,3-tetramethylbutyl)-5′-(α,α-dimethylbenzyl)phenyl]benzotriazole.

3.2.2-Hydroxybenzophenones, for example the 4-hydroxy, 4-methoxy, 4-octyloxy, 4-decyloxy, 4-dodecyloxy, 4-benzyloxy, 4,2′,4′-trihydroxy and 2′-hydroxy-4,4′-dimethoxy derivatives.

3.3. Esters of substituted and unsubstituted benzoic acids, for example 4-tert-butylphenyl salicylate, phenyl salicylate, octylphenyl salicylate, dibenzoyl resorcinol, bis(4-tert-butylbenzoyl)resorcinol, benzoyl resorcinol, 2,4-di-tert-butylphenyl 3,5-di-tert-butyl-4-hydroxybenzoate, hexadecyl 3,5-di-tert-butyl-4-hydroxybenzoate, octadecyl 3,5-di-tert-butyl-4-hydroxybenzoate, 2-methyl-4,6-di-tert-butylphenyl 3,5-di-tert-butyl-4-hydroxybenzoate.

3.4. Acrylates, for example ethyl α-cyano-β,β-diphenylacrylate, isooctyl α-cyano-β,β-diphenylacrylate, methyl α-carbomethoxycinnamate, methyl α-cyano-β-methyl-p-methoxycinnamate, butyl α-cyano-β-methyl-p-methoxycinnamate, methyl α-carbomethoxy-p-methoxycinnannate and N-(β-carbomethoxy-β-cyanovinyl)-2-methylindoline.

3.5. Nickel compounds, for example nickel complexes of 2,2′-thiobis[4-(1,1,3,3-tetramethylbutyl)phenol], such as the 1:1 or 1:2 complex, with or without additional ligands such as n-butylamine, triethanolamine or N-cyclohexyldiethanolamine, nickel dibutyldithiocarbamate, nickel salts of the monoalkyl esters, e.g. the methyl or ethyl ester, of 4-hydroxy-3,5-di-tert-butylbenzylphosphonic acid, nickel complexes of ketoximes, e.g. of 2-hydroxy-4-methylphenylundecylketoxime, nickel complexes of 1-phenyl-4-lauroyl-5-hydroxypyrazole, with or without additional ligands.

3.6. Sterically hindered amines, for example bis(2,2,6,6-tetramethyl-4-piperidyl)sebacate, bis(2,2,6,6-tetramethyl-4-piperidyl)succinate, bis(1,2,2,6,6-pentamethyl-4-piperidyl)sebacate, bis(1-octyloxy-2,2,6,6-tetramethyl-4-piperidyl)sebacate, bis(1,2,2,6,6-pentamethyl-4-piperidyl) n-butyl-3,5-di-tert-butyl-4-hydroxybenzylmalonate, the condensate of 1-(2-hydroxyethyl)-2,2,6,6-tetramethyl-4-hydroxypiperidine and succinic acid, linear or cyclic condensates of N,N′-bis(2,2,6,6-tetramethyl-4-piperidyl)hexamethylenediamine and 4-tert-octylamino-2,6-di-chloro-1,3,5-triazine, tris(2,2,6,6-tetramethyl-4-piperidyl)nitrilotriacetate, tetrakis(2,2,6,6-tetra-methyl-4-piperidyl)-1,2,3,4-butanetetracarboxylate, 1,1′-(1,2-ethanediyl)-bis(3,3,5,5-tetramethylpiperazinone), 4-benzoyl-2,2,6,6-tetramethylpiperidine, 4-stearyloxy-2,2,6,6-tetramethylpiperidine, bis(1,2,2,6,6-pentamethylpiperidyl)-2-n-butyl-2-(2-hydroxy-3,5-di-tert-butylbenzyl)malonate, 3-n-octyl-7,7,9,9-tetramethyl-1,3,8-triazaspiro[4.5]decane-2,4-dione, bis(1-octyloxy-2,2,6,6-tetramethylpiperidyl)sebacate, bis(1-octyloxy-2,2,6,6-tetramethylpiperidyl)succinate, linear or cyclic condensates of N,N′-bis(2,2,6,6-tetramethyl-4-piperidyl)hexamethylenediamine and 4-morpholino-2,6-dichloro-1,3,5-triazine, the condensate of 2-chloro-4,6-bis(4-n-butylamino-2,2,6,6-tetramethylpiperidyl)-1,3,5-triazine and 1,2-bis(3-aminopropylamino)ethane, the condensate of 2-chloro-4,6-di-(4-n-butylamino-1,2,2,6,6-pentamethylpiperidyl)-1,3,5-triazine and 1,2-bis(3-aminopropylamino)ethane, 8-acetyl-3-dodecyl-7,7,9,9-tetramethyl-1,3,8-triazaspiro[4.5]decane-2,4-dione, 3-dodecyl-1-(2,2,6,6-tetramethyl-4-piperidyl)pyrrolidine-2,5-dione, 3-dodecyl-1-(1,2,2,6,6-pentamethyl-4-piperidyl)pyrrolidine-2,5-dione, a mixture of 4-hexadecyloxy- and 4-stearyloxy-2,2,6,6-tetramethylpiperidine, a condensate of N,N′-bis(2,2,6,6-tetramethyl-4-piperidyl)hexamethylenediamine and 4-cyclohexylamino-2,6-dichloro-1,3,5-triazine, a condensate of 1,2-bis(3-aminopropylamino)ethane and 2,4,6-trichloro-1,3,5-triazine as well as 4-butylamino-2,2,6,6-tetramethylpiperidine (CAS Reg. No. [136504-96-6]); a condensate of 1,6-hexanediamine and 2,4,6-trichloro-1,3,5-triazine as well as N,N-dibutylamine and 4-butylamino-2,2,6,6-tetramethylpiperidine (CAS Reg. No. [192268-64-7]); N-(2,2,6,6-tetramethyl-4-piperidyl)-n-dodecylsuccinimide, N-(1,2,2,6,6-pentamethyl-4-piperidyl)-n-dodecylsuccinimide, 2-undecyl-7,7,9,9-tetramethyl-1-oxa-3,8-di-aza-4-oxospiro[4,5]decane, a reaction product of 7,7,9,9-tetramethyl-2-cycloundecyl-1-oxa-3,8-diaza-4-oxospiro[4,5]decane and epichlorohydrin, 1,1-bis(1,2,2,6,6-pentamethyl-4-piperidyloxycarbonyl)-2-(4-methoxyphenyl)ethene, N,N′-bis-formyl-N,N′-bis(2,2,6,6-tetramethyl-4-piperidyl)hexamethylenediamine, a diester of 4-methoxymethylenemalonic acid with 1,2,2,6,6-pentamethyl-4-hydroxypiperidine, poly[methylpropyl-3-oxy-4-(2,2,6,6-tetrannethyl-4-piperidyl)]siloxane, a reaction product of maleic acid anhydride-α-olefin copolymer with 2,2,6,6-tetramethyl-4-aminopiperidine or 1,2,2,6,6-pentamethyl-4-aminopiperidine.

3.7. Oxamides, for example 4,4′-dioctyloxyoxanilide, 2,2′-diethoxyoxanilide, 2,2′-dioctyloxy-5,5′-di-tert-butoxanilide, 2,2′-didodecyloxy-5,5′-di-tert-butoxanilide, 2-ethoxy-2′-ethyloxanilide, N,N′-bis(3-dimethylaminopropyl)oxamide, 2-ethoxy-5-tert-butyl-2′-ethoxanilide and its mixture with 2-ethoxy-2′-ethyl-5,4′-di-tert-butoxanilide, mixtures of o- and p-methoxy-disubstituted oxanilides and mixtures of o- and p-ethoxy-disubstituted oxanilides.

3.8. 2-(2-Hydroxyphenyl)-1,3,5-triazines, for example 2,4,6-tris(2-hydroxy-4-octyloxyphenyl)-1,3,5-triazine, 2-(2-hydroxy-4-octyloxyphenyl)-4,6-bis(2,4-dimethylphenyl)-1,3,5-triazine, 2-(2,4-dihydroxyphenyl)-4,6-bis(2,4-dimethylphenyl)-1,3,5-triazine, 2,4-bis(2-hydroxy-4-propyloxyphenyl)-6-(2,4-dimethylphenyl)-1,3,5-triazine, 2-(2-hydroxy-4-octyloxyphenyl)-4,6-bis(4-methylphenyl)-1,3,5-triazine, 2-(2-hydroxy-4-dodecyloxyphenyl)-4,6-bis(2,4-dimethylphenyl)-1,3,5-triazine, 2-(2-hydroxy-4-tridecyloxyphenyl)-4,6-bis(2,4-dimethylphenyl)-1,3,5-triazine, 2-[2-hydroxy-4-(2-hydroxy-3-butyloxypropoxy)phenyl]-4,6-bis(2,4-dimethyl)-1,3,5-triazine, 2-[2-hydroxy-4-(2-hydroxy-3-octyloxypropyloxy)phenyl]-4,6-bis(2,4-dimethyl)-1,3,5-triazine, 2-[4-(dodecyloxy/tridecyloxy-2-hydroxypropoxy)-2-hydroxyphenyl]-4,6-bis(2,4-dimethylphenyl)-1,3,5-triazine, 2-[2-hydroxy-4-(2-hydroxy-3-dodecyloxypropoxy)-phenyl]-4,6-bis(2,4-dimethylphenyl)-1,3,5-triazine, 2-(2-hydroxy-4-hexyloxy)phenyl-4,6-diphenyl-1,3,5-triazine, 2-(2-hydroxy-4-methoxyphenyl)-4,6-diphenyl-1,3,5-triazine, 2,4,6-tris[2-hydroxy-4-(3-butoxy-2-hydroxypropoxy)phenyl]-1,3,5-triazine, 2-(2-hydroxyphenyl)-4-(4-methoxyphenyl-6-phenyl-1,3,5-triazine, 2-{2-hydroxy-4-[3-(2-ethylhexyl-1-oxy)-2-hydroxypropyloxy]phenyl}-4,6-bis(2,4-dimethylphenyl)-1,3,5-triazine.

4. Metal deactivators, for example N,N′-diphenyloxamide, N-salicylal-N′-salicyloyl hydrazine, N,N′-bis(salicyloyl)hydrazine, N,N′-bis(3,5-di-tert-butyl-4-hydroxyphenylpropionyl)hydrazine, 3-salicyloylamino-1,2,4-triazole, bis(benzylidene)oxalyl dihydrazide, oxanilide, isophthaloyl dihydrazide, sebacoyl bisphenylhydrazide, N,N′-diacetyladipoyl dihydrazide, N,N′-bis(salicyloyl)oxalyl dihydrazide, N,N′-bis(salicyloyl)thiopropionyl dihydrazide.

5. Phosphites and phosphonites, for example triphenyl phosphite, diphenylalkyl phosphites, phenyldialkyl phosphites, tris(nonylphenyl)phosphite, trilauryl phosphite, trioctadecyl phosphite, distearylpentaerythritol diphosphite, tris(2,4-di-tert-butylphenyl)phosphite, diisodecyl pentaerythritol diphosphite, bis(2,4-di-tert-butylphenyl)pentaerythritol diphosphite, bis(2,4-dicumylphenyl)pentaerythritol diphosphite, bis(2,6-di-tert-butyl-4-methylphenyl)pentaerythritol diphosphite, diisodecyloxypentaerythritol diphosphite, bis(2,4-di-tert-butyl-6-methylphenyl)-pentaerythritol diphosphite, bis(2,4,6-tris(tert-butylphenyl)pentaerythritol diphosphite, tristearyl sorbitol triphosphite, tetrakis(2,4-di-tert-butylphenyl)-4,4′-biphenylene diphosphonite, 6-isooctyloxy-2,4,8,10-tetra-tert-butyl-12H-dibenz[d,g]-1,3,2-dioxaphosphocin, bis(2,4-di-tert-butyl-6-methylphenyl)methyl phosphite, bis(2,4-di-tert-butyl-6-methylphenyl)ethyl phosphite, 6-fluoro-2,4,8,10-tetra-tert-butyl-[2-methyl-dibenz[d,g]-1,3,2-dioxaphosphocin, 2,2′,2″-nitrilo-[triethyltris(3,3′,5,5′-tetra-tert-butyl-1,1′-biphenyl-2,2′-diyl)phosphite], 2-ethylhexyl(3,3′,5,5′-tetra-tert-butyl-1,1′-biphenyl-2,2′-diyl)phosphite, 5-butyl-5-ethyl-2-(2,4,6-tri-tert-butylphenoxy)-1,3,2-dioxaphosphirane.

6. Phosphorus-containing acids, phosphorus-containing acid salt, phosphorus-containing acid ester or derivative thereof:

Phosphorus-containing acids include the oxo acids of phosphorous such as the phosphoric acid, phosphonic acid and phosphinic acid. Suitable salts of the phosphous-containing acids are alkali metal salts, earth alkali metal salts or transition metal salts. Among these, calcium, barium, magnesium, sodium, potassium, manganese and aluminum salts are preferred. In particular preferred are sodium phosphinate (NaPO₂H₂, also known as sodium hypophosphite), manganese bis(phosphinate ((Mn(H₂PO₂)₂ also known as manganese(II)-hypophosphite), aluminum phosphinate (Al(H₂PO₂)₃) and mixtures thereof. Also in particular preferred are phosphonic acid esters, half-esters and mixtures thereof, especially hydroxyphenylalkylphosphonic acid esters, half-esters or mixtures thereof, for example those disclosed in WO2007006647, especially calcium bis[monoethyl(3,5-di-tert-butyl-4-hydroxybenzyl)phosphonate] (Irgamod® 195, commercially available from BASF SE), or diethyl (3,5-di-tert-butyl-4-hydroxybenzyl)phosphonate (Irgamod® 295, commercially available from BASF SE).

7. Hydroxylamines, for example N,N-dibenzylhydroxylamine, N,N-diethylhydroxylamine, N,N-dioctylhydroxylamine, N,N-dilaurylhydroxylamine, N,N-ditetradecylhydroxylamine, N,N-dihexadecylhydroxylamine, N,N-dioctadecylhydroxylamine, N-hexadecyl-N-octadecylhydroxylamine, N-heptadecyl-N-octadecylhydroxylamine, N,N-dialkylhydroxylamine derived from hydrogenated tallow amine.

8. Nitrones, for example N-benzyl-alpha-phenylnitrone, N-ethyl-alpha-methylnitrone, N-octyl-alpha-heptylnitrone, N-lauryl-alpha-undecyInitrone, N-tetradecyl-alpha-tridecyInitrone, N-hexadecyl-alpha-pentadecyInitrone, N-octadecyl-alpha-heptadecyInitrone, N-hexadecyl-alpha-heptadecyInitrone, N-ocatadecyl-alpha-pentadecyInitrone, N-heptadecyl-alpha-heptadecyInitrone, N-octadecyl-alpha-hexadecyInitrone, nitrone derived from N,N-dialkylhydroxylamine derived from hydrogenated tallow amine.

9. Thiosynergists, for example dilauryl thiodipropionate or distearyl thiodipropionate.

10. Peroxide scavengers, for example esters of P-thiodipropionic acid, for example the lauryl, stearyl, myristyl or tridecyl esters, mercaptobenzimidazole or the zinc salt of 2-mercaptobenzimidazole, zinc dibutyldithiocarbamate, dioctadecyl disulfide, pentaerythritol tetrakis(p-dodecylmercapto)propionate.

11. Polyamide stabilisers, for example copper salts in combination with iodides and/or phosphorus compounds and salts of divalent manganese.

12. Basic co-stabilisers, for example melamine, polyvinylpyrrolidone, dicyandiamide, triallyl cyanurate, urea derivatives, hydrazine derivatives, amines, polyamides, polyurethanes, alkali metal salts and alkaline earth metal salts of higher fatty acids, for example calcium stearate, zinc stearate, magnesium behenate, magnesium stearate, sodium ricinoleate and potassium palmitat, antimony pyrocatecholate or zinc pyrocatecholate. The polyamide resin preferably does not contain barium stearate.

13. Other additives, for example plasticisers, lubricants, flowcontrol agents, flameproofing agents, mold release agents and blowing agents.

14. Benzofuranones and indolinones, for example those disclosed in U.S. Pat. No. 4,325,863; U.S. Pat. No. 4,338,244; U.S. Pat. No. 5,175,312; U.S. Pat. No. 5,216,052; U.S. Pat. No. 5,252,643; DE-A-4316611; DE-A-4316622; DE-A-4316876; EP-A-0589839 or EP-A-0591102 or 3-[4-(2-acetoxyethoxy)-phenyl]-5,7-di-tert-butylbenzofuran-2-one, 5,7-di-tert-butyl-3-[4-(2-stearoyloxyethoxy)phenyl]-benzofuran-2-one, 3,3′-bis[5,7-di-tert-butyl-3-(4-[2-hydroxyethoxy]phenyl)benzofuran-2-one], 5,7-di-tert-butyl-3-(4-ethoxyphenyl)benzofuran-2-one, 3-(4-acetoxy-3,5-dimethylphenyl)-5,7di-tert-butylbenzofuran-2-one, 3-(3,5-dimethyl-4-pivaloyloxyphenyl)-5,7-di-tert-butylbenzo-furan-2-one, 3-(3,4-dimethylphenyl)-5,7-di-tert-butylbenzofuran-2-one, 3-(2,3-dimethylphenyl)-5,7-di-tert-butylbenzofuran-2-one.

15. Fillers or reinforcing agents comprise, for example, glass fibers in the form of glass fabrics, glass mats or filament glass rovings, chopped glass, glass beads, and wollastonite. Glass fibers can be incorporated both in the form of short glass fibers and in the form of continuous fibers (rovings).

16. Antistatic agents, for example, amine derivatives such as N,N-bis(hydroxyalkyl)-alkylamines or -alkylenamines, polyethylene glycol esters and ethers, ethoxylated carboxylic esters and carboxamides, and glycerol monostearates and distearates, and also mixtures thereof.

17. Biocides can be a pesticide or an antimicrobial.

The at least one compound of the formula I is present in an amount of 0.001 to 5% by weight, preferably 0.01 to 3% by weight, for example 0.001 to 3%, 0.01 to 2%, 0.01 to 1.5% or 0.025 to 1%, relative to the weight of the polyamide resin.

The weight ratio of the compound of the formula (I) to the optional above described components, if present, is preferably 1:100 to 100:1, for example 1:90 to 90:1, 1:80 to 80:1, 1:70 to 70:1, 1:60 to 60:1, 1:50 to 50:1, 1:40 to 40:1, 1:30 to 30:1, 1:20 to 20:1, 1:10 to 10:1, 1:5 to 5:1, 1:4 to 4:1, 1:3 to 3:1, 1:2 to 2:1 or 1:1.

According to the present invention, a method is provided for improving at least one solid state material property of a polyamide resin, the method comprising the steps of

a) providing a polyamide;
b) providing at least one urea compound of the formula I as defined above; and
c) incorporating the urea compound of the formula I into the polyamide.

The polyamide is preferably selected from an aliphatic polyamide homopolymer, aliphatic polyamide copolymer, a partially aromatic polyamide and mixtures thereof as defined above. The polyamide resin may include other components or additives such as colorants, antioxidants, UV-absorber, light stabilizers, reinforcing materials, fillers, antifogging agents, mold release agents, biocides, antistatic agents and rheology modifiers as defined above. In the urea compound of the formula I, the radicals R¹, R², Z and the index x has preferably one of the preferred meanings. The urea compound of the formula I may be present in an amount of from 0.001 to 5% by weight, preferably 0.01 to 3% by weight, more preferably 0.05 to 2% by weight, relative to the weight of the polymer resin.

By the present method, polyamide resins are provided with improved solid state properties. Especially, the solid state properties selected from mechanical properties and gloss are improved. The polyamide resins made according to the method of the present invention have improved tensile properties and notched impact toughness. The tensile properties are preferably selected from yield stress, yield strain, tensile strain at break, tensile stress at break, modulus of elasticity and modulus of shear.

The at least one compound of the formula I and optional further components may be added to the polyamide resin individually or mixed with one another. If desired, the individual additives can be mixed with one another for example in the melt (melt blending) before incorporation into the polyamide polymer.

The incorporation of the compound of formula I and the optional incorporation of such conventional components into the polyamide resins can be carried out by any known process. This incorporation can be carried out, for example, by dry blending, by extruding a mixture of the various constituents, by the conventional masterbatch technique, adding a concentrate of the additive, adding the additive such as a filler mixed in a polymeric carrier, or the like.

The incorporation can be carried out in any heatable container equipped with a stirrer, e.g. in a closed apparatus such as a kneader, mixer or stirred vessel. Examples of processing of the compositions according to the present invention are: injection blow molding, extrusion, blow molding, extrusion blow molding, rotomolding, in mold decoration (back injection), slush molding, injection molding, co-injection molding, forming, compression molding, pressing, film extrusion (cast film; blown film), fiber spinning (woven, non-woven), drawing (uniaxial, biaxial), annealing, deep drawing, calandering, mechanical transformation, sintering, coextrusion. The incorporation is preferably carried out in an extruder or in a kneader according to methods known in literature.

It is immaterial whether processing takes place in an inert atmosphere or in the presence of oxygen.

The polyamide resins comprising the compound of formula I may be formed into shaped articles using any suitable melt-processing technique, such as injection molding, extrusion, blow molding, injection blow molding, thermoforming and the like. The polyamide resin comprising the compound of formula I is usually a film, fiber, sheet, pipe, semi-finished product, granulate, container, blow-molded article or monofilament. The film can be a single layer film or a multilayer film or fibres.

Polyamide articles comprising the compound of formula I, feature high strength, high stiffness, high notched impact toughness, excellent tensile strain at break, excellent tensile stress at break, excellent modulus of elasticity and excellent modulus of shear, this being particularly important for the use in the optical, automotive, aircraft, electrical/electronic, sports and leisure, mechanical engineering industries, or in the field of aggressive media.

Without intending to limit the generality of the foregoing, articles formed from the polyamide resin comprising the compound of formula I can include machinery components and housings of toughness, good dimensional stability at elevated temperatures and low tensile stress at break such as gears, housings such as filter housings or solenoid valve housings, electrical flow heaters, trailing cable attachments, electrically insulating parts, sight windows for tanks or reservoirs, e.g. for fuel and/or oil, lids, spectacle frames, spectacle glasses, lenses for technical devices, viewing glasses for heating technics, filter cups for drinking water treatment, bottles, flowmeters for gases or liquid media, clock cases, wrist watch cases, motor vehicle accessories, lamp cases, reflectors for lamps, switches with back lights, surgical materials, cartridges or decorative partssporting goods, or packaging material.

The surface gloss is measured in accordance with DIN 67530 (measurement angle 20° and 60°). Yield stress, yield strain, tensile stress at break, tensile strain at break and Young's modulus are measured in accordance with EN ISO 527-2. The Charpy notched impact toughness is determined according to DIN EN ISO 179-2, notch S, injected, at 23° C. Storage modulus G′ and loss modulus G″ were determined according to ISO 6721-7 in the temperature range from 15.1° to 197.3° C.

The present invention is now illustrated in further detail by the following examples. However, the purpose of the following examples is only illustrative and is not intended to limit the present invention to them.

### PREPARATION OF COMPOUNDS OF THE FORMULA I

### I.1 Compounds of the Formula I, where x=1 and R¹=R²

### Example 1

### 1,1′-(trans-1,4-cyclohexylene)bis(3-(tert-butyl)urea)

A solution of tert-butylisocyanate (3.90 g, 0.039 mol) in dry tetrahydrofuran (THF) (50 mL) was added slowly to a solution of trans-1,4-diaminocyclohexane (2.10 g, 0.019 mol) in dry THF (100 mL) under inert atmosphere. The resulting mixture was heated to reflux and stirred for 24 h. The precipitate was filtrated and washed with additional dry THF. The resulting white solid was recrystallized from N,N-dimethylformamide (DMF) and dried under high vacuum.

MS (70 eV): 312 (M+)

### Example 2

### 1,1′-(trans-1,4-cyclohexylene)bis(3-(cyclohexyl)urea)

A solution of cyclohexyl isocyanate (5.49 g, 0.044 mol) in dry THF (50 mL) was added slowly to a solution of trans-1,4-diaminocyclohexane (2.51 g, 0.022 mol) in dry THF (100 mL) under inert atmosphere. The resulting mixture was heated to reflux and stirred for 24 h. The precipitate was filtrated and washed with additional dry THF. The resulting white solid was recrystallized from DMF and dried under high vacuum.

MS (70 eV): 364 (M+)

### Example 3

### 1,1′-(trans-1,4-cyclohexylene)bis(3-(iso-propyl)urea)

A solution of isopropylamine (1.25 g, 0.022 mol) in dry THF (50 mL) was added slowly to a solution of trans-1,4-cylcohexane diisocyanate (1.75 g, 0.011 mol) in dry THF (100 mL) under inert atmosphere. The resulting mixture was heated to reflux and stirred for 24 h. The precipitate was filtrated and washed with additional dry THF. The resulting white solid was recrystallized from DMF and dried under high vacuum.

MS (70 eV): 284 (M+)

### Example 4

### 1,1′-(trans-1,4-cyclohexylene)bis(3-(1-ethylpropyl)urea)

A solution of 3-aminopentane (2.20 g, 0.025 mol) in dry THF (50 mL) was added slowly to a solution of trans-1,4-cylcohexane diisocyanate (2.00 g, 0.012 mol) in dry THF (100 mL) under inert atmosphere. The resulting mixture was heated to reflux and stirred for 24 h. The precipitate was filtrated and washed with additional dry THF. The resulting white solid was recrystallized from DMF and dried under high vacuum.

MS (70 eV): 340 (M+)

### Example 5

### 1,1′-(cis-1,4-cyclohexylene)bis(3-(cyclohexyl)urea)

A solution of isocyanatocyclohexane (3.25 g, 0.026 mol) in dry THF (50 mL) was added slowly to a solution of cis-1,4-cyclohexanediamine (1.50 g, 0.013 mol) in dry THF (100 mL) under inert atmosphere. The resulting mixture was heated to reflux and stirred for 24 h. The precipitate was filtrated and washed with additional dry THF. The resulting white solid was recrystallized from MeOH and dried under high vacuum.

Melting point: 252° C.

MS (70 eV): 364 (M+)

### Example 6

### 1,1′-(cis-1,4-cyclohexylene)bis(3-(tert-butyl)urea)

A solution of tert-butylisocyanate (2.57 g, 0.026 mol) in dry THF (50 mL) was added slowly to a solution of cis-1,4-cyclohexanediamine (1.50 g, 0.013 mol) in dry THF (100 mL) under inert atmosphere. The resulting mixture was heated to reflux and stirred for 24 h. The precipitate was filtrated and washed with additional dry THF. The resulting white solid was recrystallized from MeOH and dried under high vacuum.

Melting point: 319° C.

MS (70 eV): 312 (M+)

The compounds of Examples 7 to 13 were prepared in an analogous manner.

### Example 7

### 1,1′-(trans-1,4-cyclohexylene)bis(3-(1,1-dimethylpropyl)urea)

MS (70 eV): 340 (M+)

### Example 8

### 1,1′-(trans-1,4-cyclohexylene)bis(3-(tert-octyl)urea)

MS (70 eV): 426 (M+)

### Example 9

### 1,1′-(trans-1,4-cyclohexylene)bis(3-(1,5-dimethylhexyl)urea)

MS (70 eV): 425 (M+)

### Example 10

### 1,1′-(trans-1,4-cyclohexylene)bis(3-(1-adamantyl)urea)

MS (70 eV): 468 (M+)

### Example 11

### 1,1′-(trans-1,4-cyclohexylene)bis(3-n-butylurea)

Melting point: 358° C.

MS (70 eV): 312 (M+)

### Example 12

### 1,1′-(trans-1,4-cyclohexylene)bis(3-(n-propyl)urea)

MS (70 eV): 284 (M+)

### Example 13

### 1,1′-(trans-1,4-cyclohexylene)bis(3-(ethyl)urea)

MS (70 eV): 256 (M+)

### Example 14

### (4-ureidocyclohexyl)urea

Trans-1,4-diaminocyclohexane (2.10 g, 0.019 mol) was dissolved in water (40 mL). The solution was brought to pH 5-7 by the addition of HCl. 3.30 g of potassium cyanate was added slowly under stirring. The resulting mixture was heated to reflux and stirred for 24 h. The precipitate was filtrated and washed with additional water. The resulting white solid was dried under high vacuum.

### I.2. Compounds of the formula I, where x=1 and R¹ is different from R²

### Example 15

### 1-tert-butyl-3-[4-(cyclohexylcarbamoylamino)cyclohexyl]urea

### 15.1 trans-1-(4-aminocyclohexyl)-3-cyclohexylurea

A solution of trans-1,4-diaminocyclohexane (6.15 g, 0.054 mol) in dry THF (500 mL) was cooled to −40° C. in a cooling bath (isopropyl alcohol/dry ice) under inert atmosphere. Isocyanatocyclohexane (6.75 g, 0.054 mol) in dry THF (100 mL) was added slowly under heavy stirring. The resulting mixture was stirred for another 24 h at room temperature. The precipitating white solid was filtrated, suspended in water and acidified to pH 2 (HCl). The emerging clear solution was again filtrated and the filtrate was brought to pH 8 (NaOH) whereupon trans-1-(4-aminocyclohexyl)-3-cyclohexylurea precipitated as a white solid.

### 15.2 1-tert-butyl-3-[4-(cyclohexylcarbamoylamino)cyclohexyl]urea

A solution of tert-butylisocyanate (1.17 g, 0.012 mol) in dry N-methyl-2-pyrrolidone (NMP) (50 mL) was added slowly to a solution of trans-1-(4-aminocyclohexyl)-3-cyclohexylurea (2.83 g, 0.012 mol) in dry NMP (100 mL) under inert atmosphere. The resulting mixture was heated to 70° C. and stirred for 24 h. The solution was precipitated in 1 M HCl and filtered off. The resulting white solid was washed with THF, recrystallized from DMF and dried under high vacuum.

Melting point: 325° C.

MS (70 eV): 338 (M+)

### I.3 Compounds of the formula I, where x=2 and R¹=R²

### Example 16

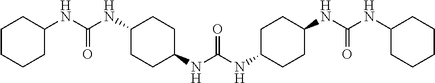 [SMILES: O=C(NC1CCCCC1)N[C@H]1CC[C@H](NC(=O)N[C@H]2CC[C@H](NC(=O)NC3CCCCC3)CC2)CC1]

### 16.1 trans-1-(4-aminocyclohexyl)-3-cyclohexylurea

Trans-1,4-diaminocyclohexane (6.15 g, 0.054 mmol) was added in a flame dried Schlenk flask and dissolved in THF (500 mL) under argon atmosphere. The solution was cooled to −40° C. in a cooling bath (isopropyl alcohol/dry ice) and cyclohexyl isocyanate (6.75 g, 0.054 mmol), diluted in THF (100 mL), was added slowly under heavy stirring. The reaction mixture was stirred for 12 h at room temperature. The precipitated white solid was filtered off, suspended in water and acidified to pH 2 (HCl). The emerging clear solution was again filtrated and the filtrate was brought to pH 8 (NaOH) whereupon the trans-1-(4-aminocyclohexyl)-3-cyclohexylurea precipitated as a white solid.

### 16.2

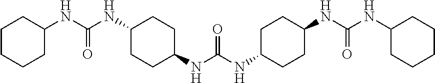 [SMILES: O=C(NC1CCCCC1)N[C@H]1CC[C@H](NC(=O)N[C@H]2CC[C@H](NC(=O)NC3CCCCC3)CC2)CC1]

A flask was charged with trans-1-(4-aminocyclohexyl)-3-cyclohexylurea in THF and phosgene was bubbled in. After completion of the reaction, excess phosgene and the solvent were removed under reduced pressure to give the title compound.

### I.4 Compounds of the formula I, where x=3 and R¹=R²

### Example 17

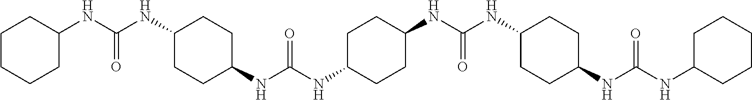 [SMILES: O=C(NC1CCCCC1)N[C@H]1CC[C@H](NC(=O)N[C@H]2CC[C@H](NC(=O)N[C@H]3CC[C@H](NC(=O)NC4CCCCC4)CC3)CC2)CC1]

Trans-1-(4-aminocyclohexyl)-3-cyclohexylurea (3.2 g, 13 mmol) was added in a flame dried Schlenk flask and dissolved in NMP under argon atmosphere. Trans-1,4-cyclohexane diisocyanate (1 g, 6 mmol) diluted in NMP was added slowly under heavy stirring. The resulting mixture was heated to 80° C. and stirred for 12 h. The solution was precipitated in 1M HCl and filtered off. The resulting white solid was washed with THF and dried under vacuum for 2 h (70° C., 100 mbar).

MS (70 eV): 265 (M+)

The following general procedures were used in the working examples unless otherwise noted.

### Mixing Procedure:

Polyamide pellets and the urea compound of the formula I were weighted exactly at a concentration of 1.0% by weight. The composition was then tumble-mixed. The above mentioned mixture was then compounded in a co-rotating twin-screw compounder (ZSK 18) at a rotational speed of 300 rpm at a melt temperature of 260° C. and a throughput of 6 kg per hour. Neat polyamide was treated in the same way to produce a blank control sample.

The following polyamide was used:
Ultramid® B27, available from BASF SE, Germany: PA 6 grade

### Injection Molding:

Injection molding was performed on an injection moulding machine with 30 mm screw diameter at a melt temperature of 260° C. The melt was injected into molds with a mold temperature of 80° C. Holding pressure was 600 bar. Test specimens produced were standard tensile bars according to DIN EN ISO 527-2, Typ 1A, and Charpy bars according to IS0179-2/1eA(F).

Compositions comprising the compound of formula I, reference and comparison compositions listed in table I below were prepared as described above, the thickness of the specimen being set to 4.0 mm.

TABLE I

| | | Compound | | | |
|---|---|---|---|---|---|
| | | from | | | |
| | PA 6 | Example 1 | Antioxidans* | Calcium | Talc |
| | [wt.-%] | [wt.-%] | [wt.-%] | Stearate*** | IT Extra |
| Reference | 100 | — | — | — | — |
| IC 1 | 99.0 | 1.0 | — | — | — |
| IC 2 | 98.20 | 1.0 | 0.3 | 0.5 | — |
| CC 1 | 99.20 | — | 0.3 | 0.5 | — |
| CC 2 | 99.00 | — | — | — | 1.0 |
| CC 3 | 98.20 | — | 0.3 | 0.5 | 1.0 |

*N,N′-hexane-1,6-diylbis[3-(3,5-di-tert-butyl-4-hydroxyphenyl)propanamide], CAS 23128-74-7
**Ceasit AV, Powder Flow Aid, from Baerlocher
IC Inventive composition
CC Comparison composition

TABLE II
Selected optical properties of compositions comprising the compound
of formula I, reference composition and comparison compositions

Gloss

| | 20° | 60° |
|---|---|---|
| Reference | 89.7 | 96.4 |
| IC 1 | 119.3 | 116.5 |
| CC2 | 95.8 | 99.2 |

The use of the compounds of the formula I improves the gloss of the polyamide composition with which they are admixed, when comparison is made with a composition without said addition.

TABLE III
Tensile properties of compositions comprising the compound of
formula I, reference composition and comparison compositions

| | Yield | tensile stress | Yield | tensile strain | Young's |
|---|---|---|---|---|---|
| | stress | at break | strain | at break | Modulus |
| | [MPa] | [MPa] | [%] | [%] | [MPa] |
| Reference | 80.43 | 47.67 | 4.08 | 21.87 | 3013 |
| IC 1 | 88.31 | 55.28 | 3.88 | 14.38 | 3255 |
| IC 2 | 89.84 | 50.71 | 3.95 | 12.43 | 3251 |
| CC 1 | 88.58 | 54.7 | 3.79 | 9.91 | 3224 |
| CC2 | 91.34 | 75.92 | 3.79 | 8.01 | 3614 |
| CC3 | 93.38 | 77.86 | 3.76 | 7.98 | 3690 |

The use of the compounds of the formula I increases the value of the Young's modulus (modulus of elasticity) and tensile strain at break, when comparison is made with a composition without said addition.

TABLE IV
Charpy notched impact toughness of compositions
comprising the compound of formula I, reference
composition and comparison compositions

| | Impact | | relative change of |
|---|---|---|---|
| | toughness | standard deviation | Impact Toughness compared |
| | [kJ/m²] | [kJ/m²] | to PA 6 [%] |
| Reference | 7.5 | 0.2 | 0.0 |
| IC 1 | 8.6 | 0.4 | 14.4 |
| CC2 | 6.5 | 0.3 | −13.0 |

Polyamide resin compositions comprising the compound of the formula I display excellent notched impact toughness at 23° C. when comparison is made with a composition without said addition or with the addition of talcum. The test specimen had a thickness of 4 mm.

### DMTA-Test

Storage modulus G′ (elastic response modulus) and loss modulus G″ (viscous response modulus) were measured by Dynamic Mechanical Thermal Analysis (DMTA measured according to ISO 6721-7). Measurements were carried out on a Rheometric RDA 1 apparatus using test specimens in the dry state. The dimensions of the test specimen were length 4.0 cm, width 1.0 cm, thickness 0.1 cm (made from a press plate). Applied strain at the beginning: 0.2%, frequency 1 Hz, heating starting from 15.1° C. under nitrogen (temperature steps: 5 K). The samples were pre-conditioned at 80° C. for 3 days hours under vacuum prior testing.

TABLE V
Storage modulus G′ and loss modulus G″ of compositions comprising
the compound of formula I and reference composition

| | | | | | relative |
|---|---|---|---|---|---|
| Temper- | Reference | | IC1 | | change of |
| ature | G′ | G″ | G′ | G″ | G′ |
| [° C.] | [Pa] | [Pa] | [Pa] | [Pa] | [%] |
| 15.1 | 1.41E+09 | 5.03E+06 | 1.40E+09 | 4.69E+06 | −0.6 |
| 24.9 | 1.38E+09 | 7.94E+06 | 1.38E+09 | 6.91E+06 | −0.3 |
| 35.0 | 1.36E+09 | 1.24E+07 | 1.35E+09 | 1.27E+07 | −0.6 |
| 45.9 | 1.29E+09 | 2.84E+07 | 1.30E+09 | 2.70E+07 | 0.2 |
| 55.9 | 1.12E+09 | 7.47E+07 | 1.13E+09 | 7.20E+07 | 1.3 |
| 65.9 | 8.04E+08 | 9.33E+07 | 8.36E+08 | 9.15E+07 | 3.9 |
| 76.1 | 5.30E+08 | 6.47E+07 | 5.58E+08 | 6.70E+07 | 5.3 |
| 86.4 | 3.60E+08 | 3.98E+07 | 4.06E+08 | 4.48E+07 | 12.6 |
| 96.4 | 2.91E+08 | 2.50E+07 | 3.34E+08 | 3.00E+07 | 14.9 |
| 101.4 | 2.68E+08 | 2.02E+07 | 3.09E+08 | 2.47E+07 | 15.3 |
| 111.4 | 2.33E+08 | 1.37E+07 | 2.70E+08 | 1.75E+07 | 15.4 |
| 121.4 | 2.08E+08 | 9.84E+06 | 2.39E+08 | 1.32E+07 | 15.4 |
| 131.6 | 1.87E+08 | 7.58E+06 | 2.16E+08 | 1.04E+07 | 15.7 |
| 141.6 | 1.70E+08 | 6.27E+06 | 1.98E+08 | 8.33E+06 | 16.1 |
| 151.9 | 1.58E+08 | 5.39E+06 | 1.84E+08 | 7.01E+06 | 16.7 |
| 162.1 | 1.47E+08 | 4.87E+06 | 1.72E+08 | 5.95E+06 | 17.3 |
| 172.4 | 1.36E+08 | 4.44E+06 | 1.61E+08 | 5.35E+06 | 18.3 |
| 182.5 | 1.25E+08 | 4.40E+06 | 1.49E+08 | 4.54E+06 | 19.7 |
| 192.5 | 1.12E+08 | 4.16E+06 | 1.35E+08 | 4.18E+06 | 20.0 |
| 197.3 | 1.06E+08 | 4.22E+06 | 1.27E+08 | 3.90E+06 | 20.5 |

The glass transition temperature of the neat polyamide (dry) as well as of the composition IC1 (dry) was 64° C., determined by DTMA. As can be seen from the storage modulus and loss modulus, the change of stiffness of IC1 above T_{G} is smaller than that of the reference composition. Thus, the stiffness of IC1 is higher than that of the reference composition in the temperature range above the glass transition temperature.

1-18. (canceled)

19. A method for improving at least one solid state material property of a polyamide resin, which comprises adding to the polyamide resin at least one urea compound of the formula I 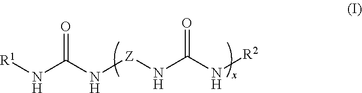
wherein
x is 1, 2 or 3;
R¹ and R² are, independently of each other, hydrogen, linear C₁-C₇-alkyl, branched C₃-C₁₀-alkyl, unsubstituted or substituted C₃-C₁₂-cycloalkyl, unsubstituted or substituted C₃-C₁₂-cycloalkyl-C₁-C₄-alkyl, unsubstituted or substituted aryl or unsubstituted or substituted aryl-C₁-C₄-alkyl; and
Z is C₃-C₁₀-alkanediyl, unsubstituted or substituted arylene, unsubstituted or substituted arylene-C₁-C₄-alkylene-arylene, unsubstituted or substituted heteroarylene, unsubstituted or substituted heteroarylene-C₁-C₄-alkylene-heteroarylene, unsubstituted or substituted C₅-C₈-cycloalkylene, unsubstituted or substituted C₅-C₈-cycloalkylene-C₁-C₄-alkylene-C₅-C₈-cycloalkylene, unsubstituted or substituted heterocycloalkylene and unsubstituted or substituted heterocycloalkylene-C₁-C₄-alkylene-heterocycloalkylene.

20. The method according to claim 19, wherein the solid state property is selected from mechanical properties and gloss.

21. The method according to claim 20, wherein the mechanical properties are selected from tensile properties and notched impact toughness.

22. The method according to claim 21, wherein the tensile properties are selected from yield stress, yield strain, tensile strain at break, tensile stress at break, modulus of elasticity and modulus of shear.

23. The method according to claim 19, wherein R¹ and R² are, independently of each other, a linear C₁-C₇-alkyl, branched C₃-C₁₀-alkyl, unsubstituted or substituted C₃-C₁₂-cycloalkyl, unsubstituted or substituted C₃-C₁₂-cycloalkyl-C₁-C₄-alkyl, unsubstituted or substituted aryl or unsubstituted or substituted aryl-C₁-C₄-alkyl.

24. The method according to claim 19, wherein R¹ and R² are, independently of each other, hydrogen, branched C₃-C₁₀-alkyl, C₅-C₁₂-cycloalkyl, C₅-C₁₂-cycloalkyl-C₁-C₄-alkyl, phenyl and phenyl-C₁-C₄-alkyl, where each ring in the four last-mentioned radicals is unsubstituted or substituted by one or more identical or different radicals R^{a}, where R^{a} is selected from C₁-C₁₀-alkyl or halogen.

25. The method according to claim 19, wherein R¹ and R² are, independently of each other, hydrogen, branched C₃-C₁₀-alkyl, which is attached to the skeleton via a secondary or tertiary carbon atom of the alkyl group, C₅-C₁₀-cycloalkyl which is unsubstituted or substituted by 1 or 2 radicals R^{a}, or phenyl which is unsubstituted or substituted by 1 or 2 radicals R^{a}.

26. The method according to claim 19, wherein R¹ and R² have the same meaning.

27. The method according to claim 19, wherein Z is C₅-C₈-alkylene, C₅-C₇-cycloalkylene, C₅-C₇-cycloalkylene-CH₂-C₅-C₇-cycloalkylene, phenylene or phenylene-CH₂-phenylene, where each ring in the four last-mentioned radicals is unsubstituted or substituted by one or two identical or different radicals R^{b}, where R^{b} is selected from C₁-C₁₀-alkyl and halogen.

28. The method according to claim 27, wherein Z is linear C₅-C₈-alkylene or C₅-C₇-cycloalkylene.

29. The method according to claim 19, wherein x is 1.

30. The method according to claim 19, wherein R¹ and R² are identical and are hydrogen, tert-butyl, 1,1-dimethylpropyl, 1,5-dimethylhexyl, 1,1,3,3-tetramethylbutyl or 1-adamantyl;
Z is trans 1,4-cyclohexylene; and
x is 1.

31. The method according to claim 19, wherein the polyamide resin is selected from the group consisting of an aliphatic polyamide homopolymer, aliphatic polyamide copolymer, a partially aromatic polyamide and mixtures thereof.

32. The method according to claim 19, wherein the polyamide polymer is selected from the group consisting of PA 6, PA 7, PA 10, PA 11, PA 12, PA 66, PA 69, PA 610, PA 612, PA 1010, PA 6/66, PA 66/6, PA 66/610 and mixtures thereof, preferably from PA 6, PA 11, PA 12, PA 66, PA 610, PA 66/6 and PA 6/66.

33. The method according to claim 32, wherein the polyamide polymer is selected from the group consisting of PA 6, PA 11, PA 12, PA 66, PA 610, PA 66/6 and PA 6/66 and in the compound of the formula I, R¹ and R² are identical and are from hydrogen, tert-butyl, 1,1-dimethylpropyl, 1,5-dimethylhexyl, 1,1,3,3-tetramethylbutyl or 1-adamantyl; Z is trans 1,4-cyclohexylene; and x is 1.

34. The method according to claim 19, wherein the polyamide resin comprises the compound of the formula I in an amount of 0.001 to 5% by weight relative to the weight of the polymer resin.

35. The method according to claim 19, wherein the polyamide resin comprises the compound of the formula I in an amount of 0.05 to 2% by weight, relative to the weight of the polymer resin.

36. The method according to claim 19, wherein the polyamide resin additionally comprises at least one further additive selected from the group consisting of colorants, antioxidants, UV-absorber, light stabilizers, reinforcing materials, fillers, antifogging agents, mold release agents, biocides, antistatic agents and rheology modifiers.
